(19) United States
(12) Patent Application Publication
(10) Pub. No.: US 2010/0257245 A1
(43) Pub. Date: Oct. 7, 2010

(54) MESSAGE COMMUNICATION APPARATUS, TRANSMITTING AND RECEIVING METHOD THEREOF

(75) Inventor: Makiko Ishiguro, Kamagaya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/726,089

(22) Filed: Mar. 17, 2010

(30) Foreign Application Priority Data
Apr. 1, 2009 (JP) 2009-089578

(51) Int. Cl. G06F 15/16

(52) U.S. Cl. 709/206

(57) ABSTRACT

The message communication apparatus that receives message from another apparatus via a network, interprets an interface definition used for dividing a message to obtain objects, and transforms the received message into divided objects to provide the objects to a request side of the divided objects, in accordance with a result of interpretation using the interface definition.

### BACKGROUND OF THE INVENTION

1. Field of the Invention

The present invention relates to a message communication apparatus that communicates messages with another apparatus via a network, and transmitting and receiving method thereof.

2. Description of the Related Art

Recently, Web Service Technology, which enables transmitting and receiving data among a plurality of apparatuses via a network, has been generally used for connecting personal computers and devices. When data is interchanged in Web Services, in general, a communication apparatus transforms an object set by an application into XML data to transmit the XML data, and also transforms the received XML data into the object to return the object to the application. A service using side application of a communication apparatus sets an object to be transmitted as an argument of a call of service providing side application, and receives an object as a return value. On the other hand, the service providing side application of a communication apparatus, by the argument of an application call, receives an object from the service using side and replies the return value as an object. Here, the object is substance, which designates data or an operation between data and data in an environment of the application.

In such application calls, in the application of the service providing side, what type of objects is to be received and what type of object is to be transmitted are defined as the interface definition document. As a general example of this interface definition document, the XML based Web Service Description Language (WSDL), which is language specification based on an XML can be given. Here, the service providing side and the service using side generate objects for executing the services based on this WSDL document. This WSDL document describes operations that indicates a unit of command of an interface and defines, for each operation, the message construction that is transmitted and received between the service using side and the service providing side. Moreover, a data type of the transmitted data and received data is also defined.

As an example, the US-2006-0123047 discloses, based on the WSDL document, the service using side generating the objects for service execution and the service providing side generating objects assigning service interface, as service execution objects which are automatically generated.

However, when an application is called, there may be a case of a type that the objects to be received by the application or the objects to be set is able to hold extremely large data. As an example, the type of array data or list data is not limited to the stored number of data, so that it is possible to set extremely large data. Moreover, even character string type data may become large in data size, the creation of such an object cannot be executed, especially, in system such as embedded device that has memory limitations due to memory restriction.

### SUMMARY OF THE INVENTION

The present invention provides a message communication apparatus that receives a message from another apparatus via a network, comprising: an interpretation unit that interprets an interface definition used for dividing a message to obtain objects; and an object transformation unit that transforms the received message into divided objects to provide the objects to a request side of the divided objects, in accordance with a result of interpretation using the interface definition.

Furthermore, the present invention provides a message communication apparatus that transmits a message to another apparatus via a network, comprising: an interpretation unit that interprets an interface definition used for dividing a message to set objects; and a message transformation unit that transforms the divided objects into a single message to transmit the message to a transmission destination of the message, in accordance with a result of interpretation using the interface definition.

Further features of the present invention will become apparent from the following description of exemplary embodiments (with reference to the attached drawings).

### BRIEF DESCRIPTION OF THE DRAWINGS

FIG. 1 illustrates an example of a hardware construction of the message communication apparatus according to the present invention;

FIG. 2 illustrates an example of the software construction of the message communication apparatus according to the present invention;

FIG. 3 is a flowchart showing process flow of the service execution object generation processing unit;

FIGS. 4A and 4B are flowcharts showing process flow of the service execution processing unit;

FIGS. 5A to 5C illustrate an example of a WSDL file which states the service defining information;

FIG. 6 illustrates an exemplary extension objective setting file which corresponds to a WSDL file;

FIG. 7 illustrates an exemplary generated service execution object;

FIG. 8 illustrates an example where the service execution object is being used in an application;

FIG. 9 illustrates an exemplary transmitting message to a service; and

FIGS. 10A and 10B illustrate an exemplary receiving message from a service.

### DESCRIPTION OF THE EMBODIMENTS

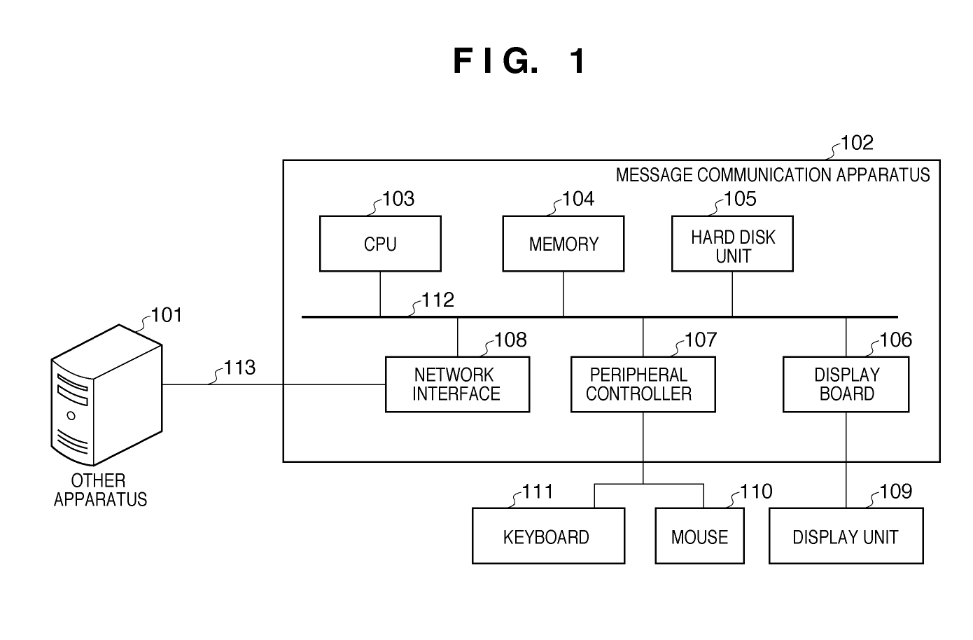

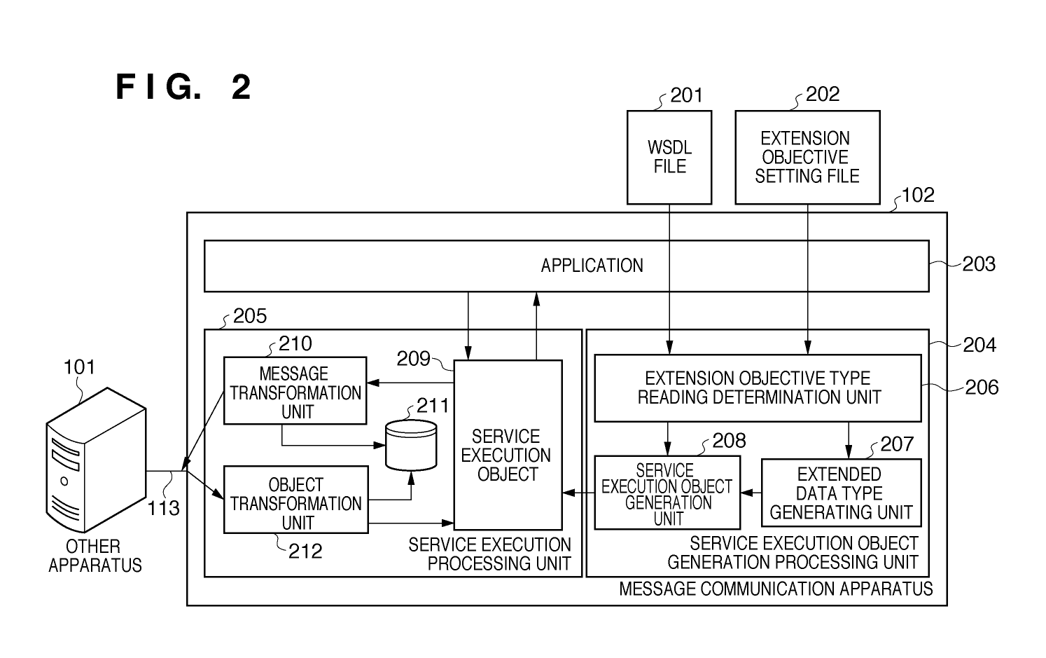

Hereinafter, embodiments according to the present invention will be explained in detail, while refereeing to the figures. First, the hardware and software construction of the message communication apparatus will be explained using FIG. 1 and FIG. 2. FIG. 1 illustrates an example of a hardware construction of a message communication apparatus 102 according to the present invention. In FIG. 1, another apparatus 101 and the message communication apparatus 102 are a computer such as a personal computer (PC) that transmits and receives massages of a Web service via a network 113. Here, the other apparatus 101 may be in the side that provides the service (service providing side) or the side that uses the service (service using side).

The message communication apparatus 102 includes a CPU 103, a memory 104, a hard disk unit (HD unit) 105, a display board 106, a peripheral controller 107, and a network interface 108. The CPU 103, according to a program, executes processes in each processing unit of the message communication apparatus 102. The program is stored in the hard disk unit 105 or the memory 104, when the CPU 103 is executing the program; it is read in to the RAM. The memory 104 includes a ROM area that stores the program and a control data, and a RAM area as a work area of the CPU 103, and further, it stores XML elements and objects.

The hard disk unit 105 includes an interface that controls access to the hard disk, and records each type of data. The display board 106 includes an interface for connecting to the display unit 109, and displays a status and process results of the message communication apparatus 102 on the display unit 109. The peripheral controller 107 includes an interface for connecting to a mouse 110 and a keyboard 111, and controls the instructions and various types of inputs to the message communication apparatus 102. The network interface 108 includes an interface for communicating between a network 113, and controls communications with the other apparatus 101.

A system bus 112 is connected to each above mentioned unit. The network 113 could be any network such as the Internet, a WAN, or a LAN, as long as the other apparatus 101 and the message communication apparatus 102 are able to communicate messages with each other.

FIG. 2 illustrates an example of the software construction of the message communication apparatus 102 according to the present invention. A Web Service Definition Language file (WSDL file) 201 is a file containing the definition of the web service interface written according to the WSDL specifications. Specifically, it is the file which describes the interface of a message regarding what kind of object is received and what kind of object is returned by the service side application. An extension objective setting file 202 is file that defines in XML whether or not to create a predetermined extended data type for the data type of message transmitting data and receiving data defined in the WSDL file 201. In addition, the WSDL file 201 and extension objective setting file 202 are files specified by a user using the display unit 109, the mouse 110 and the keyboard 111.

The message communication apparatus 102 comprises an application 203, a service execution object generation processing unit 204, and a service execution processing unit 205. The application 203, the service execution object generation processing unit 204 and the service execution processing unit 205 are realized by the execution of the program by the CPU 103.

The service execution object generation processing unit 204 receives the WSDL file 201 and the extension objective setting file 202 from the application 203, and auto generates the service execution object after analyzing the contents of the files. The service executing processing unit 205, in response to the request from the application 203, using a service execution object, sends messages to other apparatus 101 or receives messages from the other apparatus 101. The service executing processing unit 205, in case the other apparatus 101 functions as service using side, functions as the service providing side; on the other hand, in case the other apparatus 101 functions as service providing side, the service executing processing unit 205 functions as a service using side. The application 203 sets objects of the message transmitted to the other apparatus 101 or obtains objects of the message received from the other apparatus 101.

The service execution object generation processing unit 204 includes an extension objective type reading determination unit 206, an extended data type generation unit 207, and a service execution object generation unit 208. The extension objective type reading determination unit 206 reads the WSDL file 201 and the extension objective setting file 202 received from application 203, and determines whether or not the extended data type of which type is generated to the transmitting and receiving data type. Then, in response to the data type that requires extended data type, the data generation is requested to the extended data type generation unit 207. The extended data type generation unit 207 generates the data of extended data type requested by the extension objective type reading determination unit 206. The service execution object generation unit 208 generates a service execution object 209 which is able to transmit and receive messages with the other apparatus 101, based on the information passed form the extension objective type reading determination unit 206 and the extended data type generated by the extended data type generating unit 207.

The service execution processing unit 205 comprises the service execution object 209, a message transformation unit 210, a memory area 211, and an objects transformation unit 212. The memory area 211 is set within the hard disk unit 105. The service execution object 209 is a service execution object generated by the service execution object generation unit 208, and is used by the application 203. The service execution object 209 has an argument and a return value necessary for transmitting and receiving the message.

When the service execution processing unit 205 is in the service providing side, the application 203 obtains an object from the other apparatus 101 as the argument of the service execution object 209. Moreover, the object transmitted to the other apparatus 101 is set in the return value of the service execution object 209.

On one hand, when the service execution processing unit 205 is in the service using side, the application 203 sets an object to be transmitted to the other apparatus 101 in the argument of the service execution object 209, then as return value sets the object received from the other apparatus 101. Moreover, in case of service using side, the display unit 109 shown in FIG. 1, the mouse 110 and the keyboard 111 are used when calling the service execution object 209.

In case of necessity, message transformation unit 210 temporarily saves in the memory area 211 the object that is delivered as parameter or return value of service execution object 209, and then creates message and transmit it to the other apparatus 101. Here, the case of necessity is where the data type may become an extended data type. Moreover, in case data type has not become the extended data type, a message is created by using the service execution object 209 and transmitted it to the other apparatus 101.

The memory area 211 is an area that the message transformation unit 210 temporarily saves data delivered from the service execution object 209. Moreover, the memory area 211 is an area that the object transformation unit 212 temporarily saves data delivered from the other apparatus 101. Specifically, the hard disk unit 105 shown in FIG. 1 is used.

The object transformation unit 212 that receives a message from the other apparatus 101, if necessary, temporarily saves these data in the memory area 211, and returns to the object as an argument or return value of service execution object. Here, the case “if necessary” is the case where the saved data is set to the extended data type. Moreover, in case the saved data type is not the extended data type, the argument or the return value of the service execution object is returned as it is to the object.

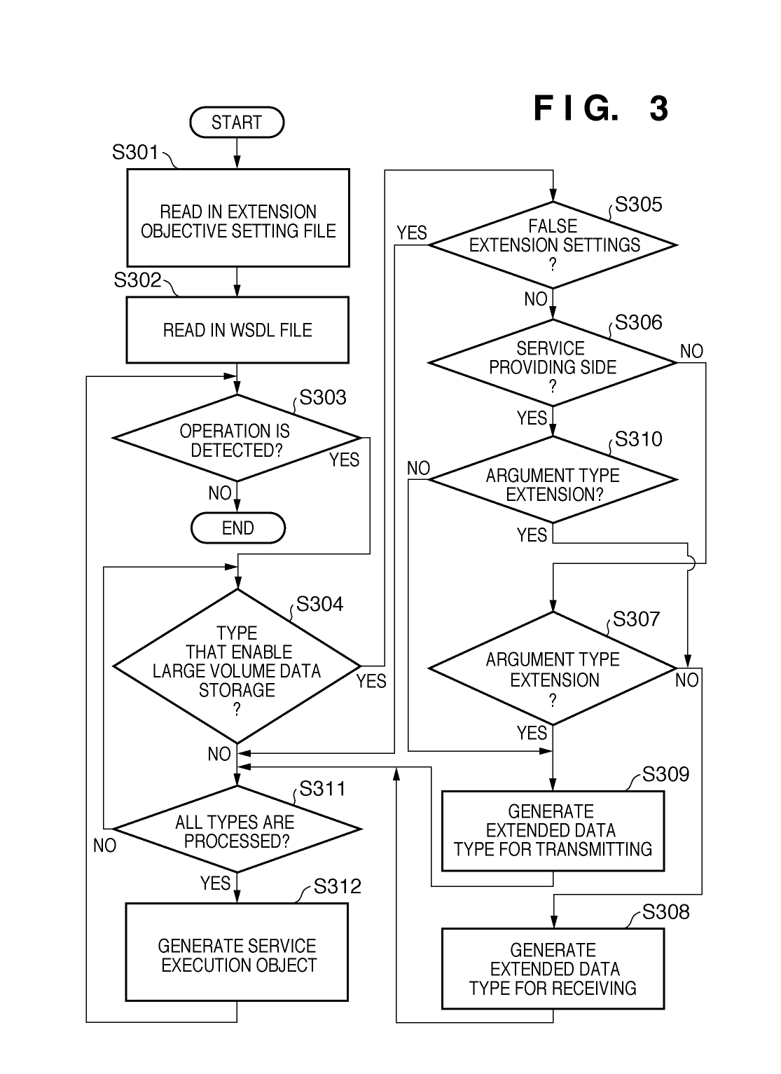

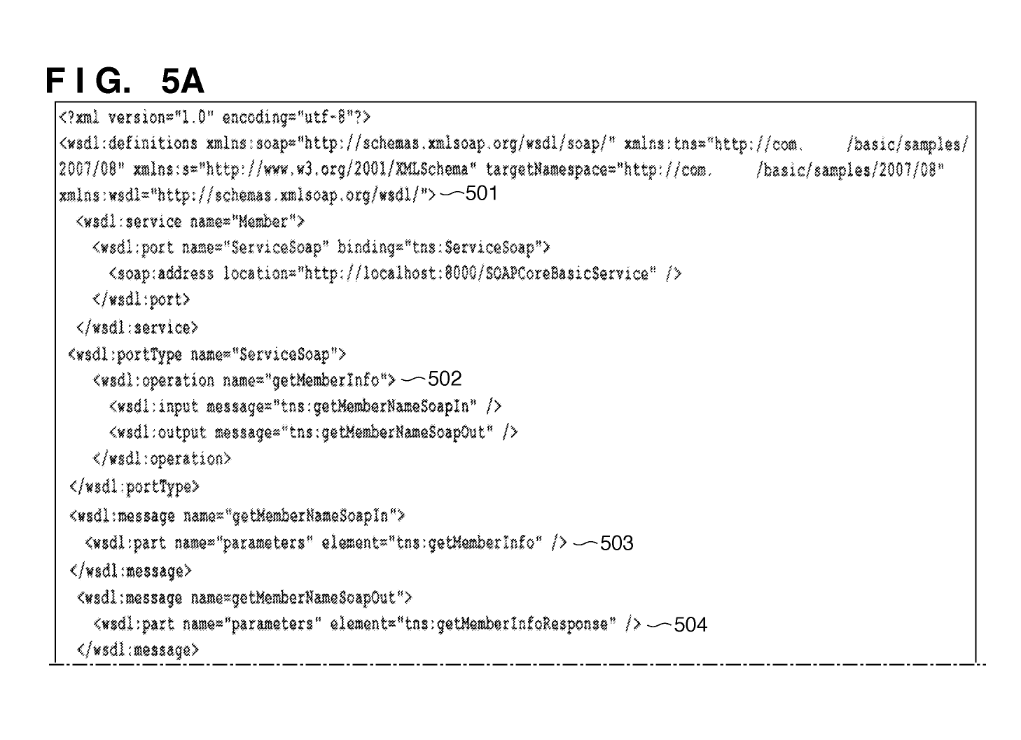

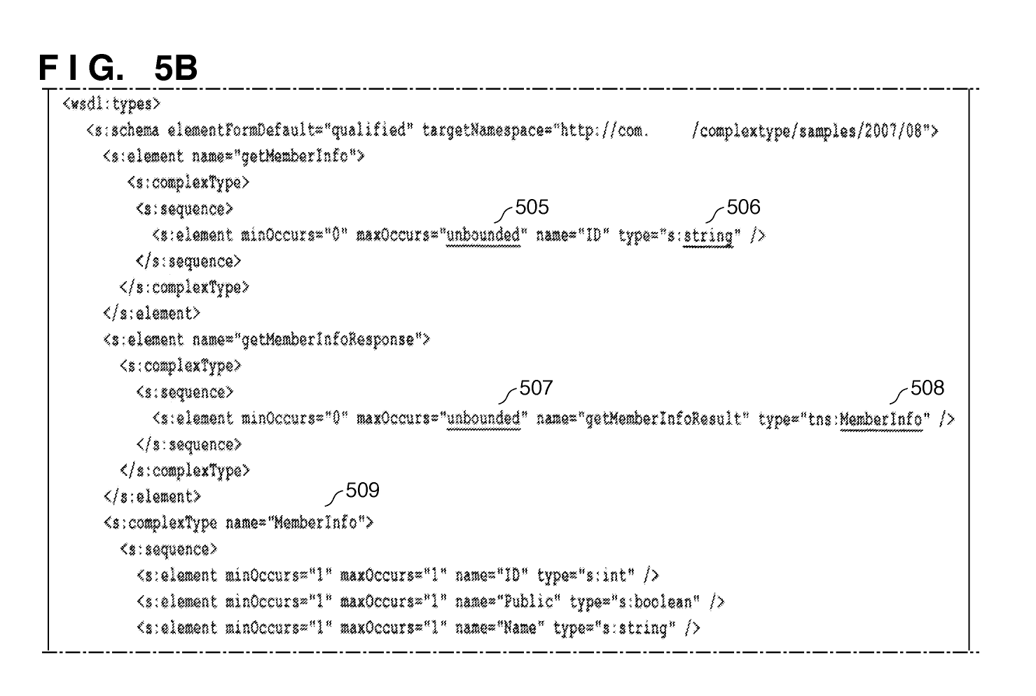

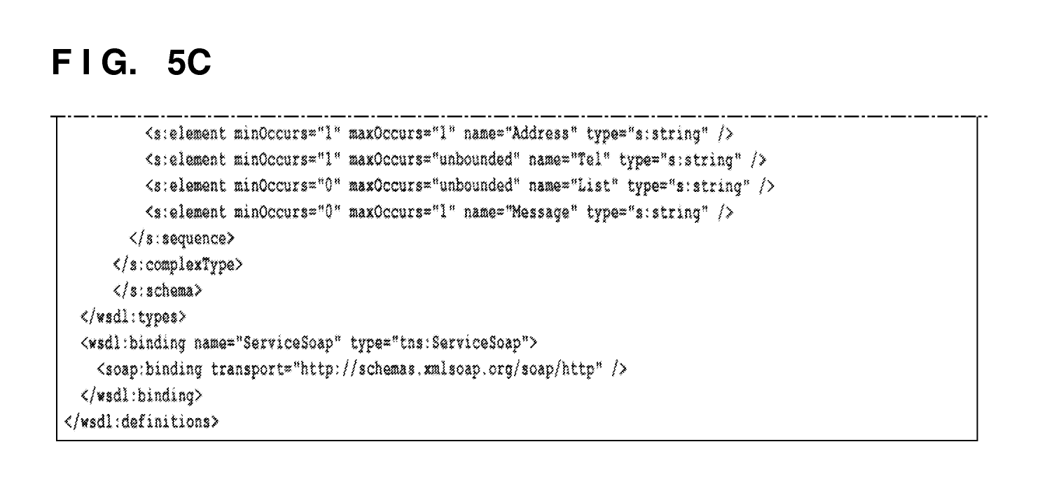

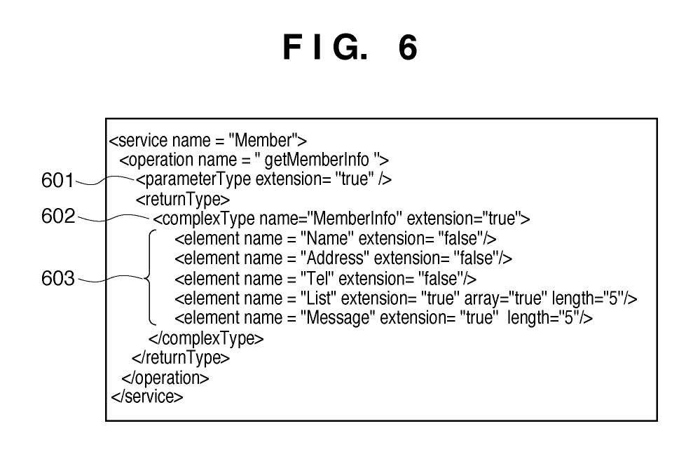

Hereinafter, using FIG. 3 to FIG. 10B the process flow of the message communication apparatus will be explained. First, using FIG. 3, the process flow of the service execution object generation processing unit 204 will be explained. In this process, a WSDL file 201 which has information of service description definition as shown in FIGS. 5A to 5C and an extension objective setting file 202 as shown in FIG. 6 are read-in, and the service execution object 209, which is able to execute the service, is generated.

First, in S301, the extension objective type reading determination unit 206 reads in the extension objective setting file 202. The extension objective setting file 202 describes what data type is transformed into the extended data type, which is not always required to be configured. Additionally, if configuring file does not exist, all the large data storage supported data types will be set as the extended data type. Here, as the large data storage supported data type, data types that can store a plurality of data such as arrays and lists are considered. Moreover, when there is no limit to the number of the characters in a simple character string type, the character string type is also considered to be a large data and the above data type also supports such cases. Hereinafter, configuration of the extension objective setting file 202 will be explained. Next, in S302, the extension objective type reading determination unit 206 reads in the WSDL file 201, and in S303, an operation is searched. In the WSDL file 201 as shown in FIGS. 5A to 5C, the service called Member 501 includes the operation which is called getMemberInfo 502.

As a search result, if the extension objective type reading determination unit 206 cannot detect an operation, the process ends, if the operation is detected, the process proceeds to S304. In S304, from the operation type information (parameter type information 503, and return value type information 504), it is determined whether or not the type is a large data storage supported data type. In this example, the argument type shown by 506 and the return value type shown by 508, both are arrays, and as shown by 505 and 507, the upper bound is unlimited; therefore, it is determined as large data types. Further, internal field information 509 that the return value is stored has String type that enable large data storage, and upper bound less arrays. Therefore, the extension objective type reading determination unit 206 determines that operation has a large data storage supported data type (YES at S304), and the process proceeds to S305.

In S305, the extension objective type reading determination unit 206, based on the extension objective setting file 202 of FIG. 6, determines whether or not an extended data type generation is specified. In the extension objective setting file 202, the argument type and the return type of the getMemberInfo operation in a Member service is set to the extended data type. In FIG. 6, an extension setting of the argument type shown in 601 is set to “true” to assign an array of the character string type to the extended data type. Moreover, the extension setting of return value type shown in 602 is also set to “true” so that a MemberInfo type array is assigned to the extended data type. This MemberInfo type has a plurality of internal fields as shown in 603. In these fields, as types that could hold a large size message, one array type and four character string types exists. In here, Name, Address and Tel is set as false, and not assigned to the extended data type. On the other hand, List is set to true, and obtaining as array is set to true, and the length of the number of arrays received at once is set to five.

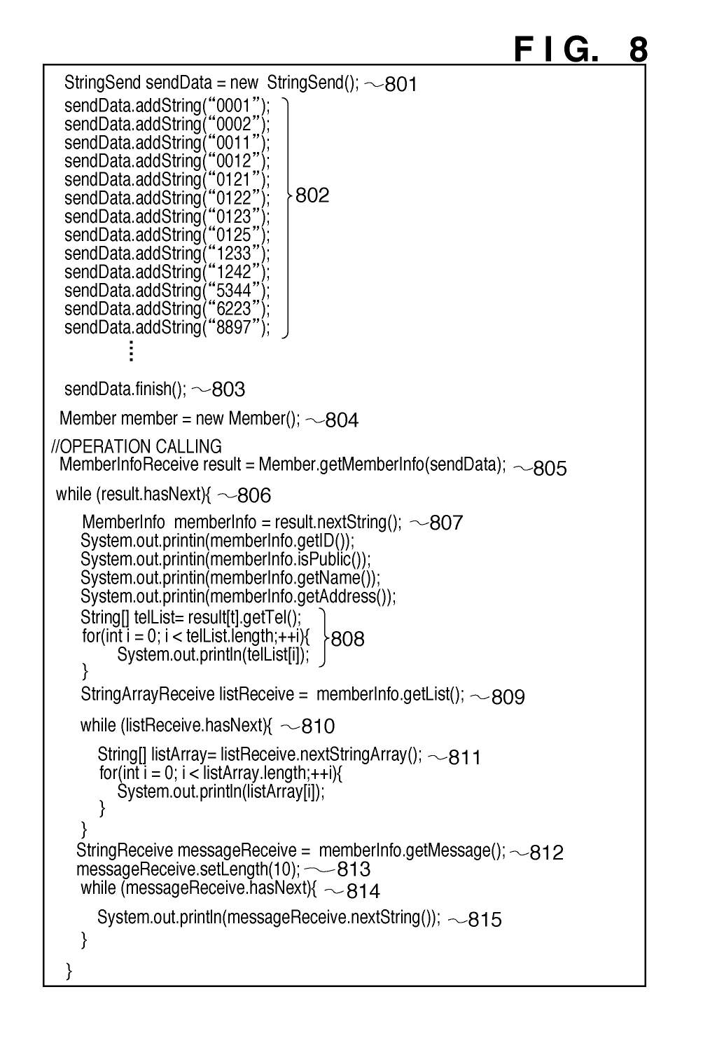

Here, as a default, the array type is set to false, and the extended data type that can obtain or set each of the data is generated. However, when the array type is set to true, the extended data type that can obtain or set the whole number of arrays is generated. This process will be detailed later using FIG. 8. Then, the Message sets the extension setting to true, and the length of the character string that received at a time is set to five. The message is not an array, therefore, the array type inevitably becomes false.

As mentioned above, among the extension setting of MemberInfo Name, Address and Tel which have type set to false, the extended data type generation is not conducted (S305: YES). On the other hand, the argument that the extension setting is set to true, in other words, List and Message within the MemberInfo type perform generation of the extended data type (S305: No). The extended data type generation unit 207 generates the extended data type according to the request by extension objective type reading determination unit 206. In the extension objective setting file 202, unless the generation of the objective type is clearly set as false, the generation of the extended data type is executed with setting as true.

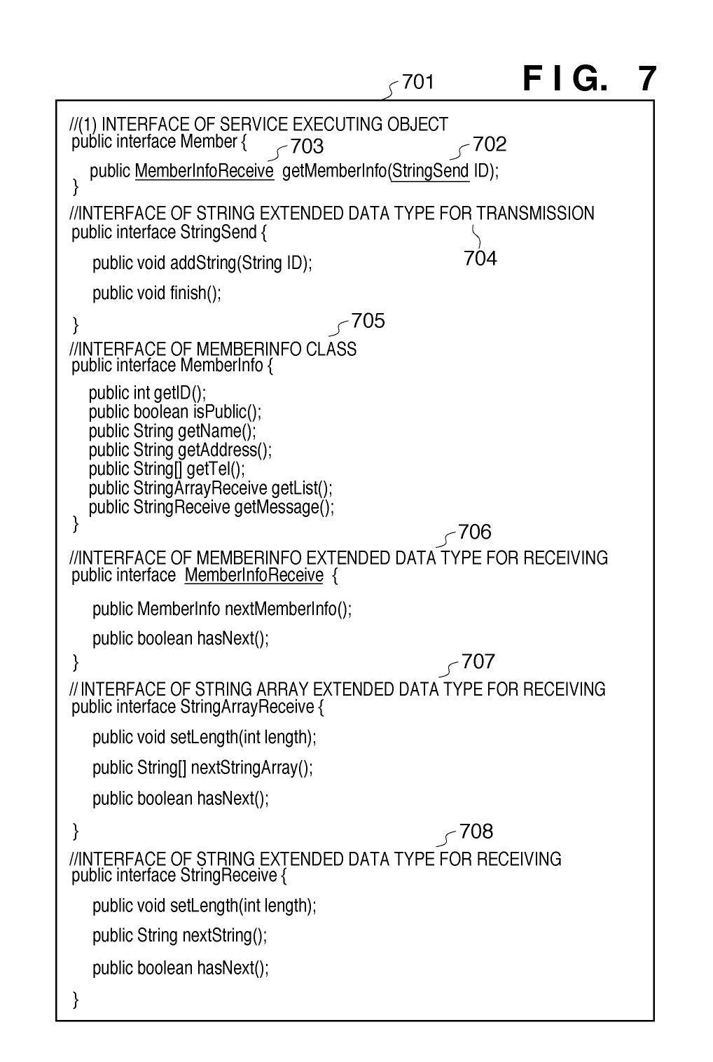

In S306, the extended data type generation unit 207 determines whether the generated service execution object is at the service using side or the service providing side. In the example shown in FIG. 7, since the service execution object 209 is in the service using side (S306: NO), the process proceeds to S307, and then whether or not the type which is extended is argument type is determined.

Here, in S307, among the return value type MemberInfo, the List and the Message are determined to be NO, and process proceeds to 5308, and then the extended data type for receiving is generated. In the interface 706 of extended data type of MemberInfo for receiving, the nextMemberInfo method that obtains the data of MemberInfo one by one, and hasNext method that notify whether there is another data item, exist.

The List among the MemberInfo is a String array extended data type for receiving, in the interface 707 of it each method of setLength, nextStringArray, and hasNext exist. In the List array extension setting, since the array type setting is set to true, the return value to the nextStringArray method is a String array. Since the number of arrays received at one time is set to five, the five arrays are returned. Additionally, the number of arrays obtained by the setLength method can be changed in between. Then, the hasNext method provides notification saying whether there is another array.

The Message among the MemberInfo is a string extended data type for receiving, each method of setLength, nextStringArray, and hasNext exist in the interface 708 of it. In the message extension setting, since the data length received at one time is set to five, character string type data of just that length is received. Additionally, the length of string obtained by the setLengh method can be changed in between the process. Then, the hasNext method provides a notification saying whether there is another array.

On one hand, the character string type, which is an argument type, is determined as YES in S307, and the process proceeds to S309, and the extended data type for transmission is generated. In the interface 704 of the String extended data type for transmitting, the addString method for setting data one by one of the character string type and finish method that notify finish setting all the data exist.

Moreover, in S306 in case the message communication apparatus 102 is in the service providing side, the process is proceeds to S310, in contrast to the case of using side, extended data type is generated so as the return value type is for transmission and the argument type is for receiving.

Next, in S311, until all the type processes in the operation are concluded, the above mentioned S304 and following steps are repeated. Then, when all the type processes in the operation are completed, the process proceeds to S312 and the service execution object generating unit 208 generates the service execution object 209. In this regards, in case there is an extended data type generated by the extended data type generating unit 207, this data type is being used.

In the interface 701 of the generated service execution object 209, as shown in FIG. 7, interface 701 of the Member corresponding to the service name is generated. In FIG. 5A, getMemberInfo method is defined corresponding to the operation name described in 502. Moreover, as the argument type 702, the extended data type for transmission generated by the service execution object generation unit 208 is set. In case the message communication apparatus 102 is in the service using side, when this service execution object is used, it becomes transmission type. Moreover, as the return value type 703, MemberInfo extended data type for receiving generated by the service execution object generation unit 208 is set. In case of service using side, when this service execution object is used, this becomes the receiving type.

Complex type MemberInfo class interface 705 is generated. Internally, each field that corresponds to 509 of FIG. 5B is defined. The field names List and the character string type field name Message have the type of string extended data type generated by the service execution object generation unit 208. In character string type field names Name and Address, array field name Tel, since extension objective setting field 202 is set to settings that does not generates the extended data type, the type is similar to the type defined in FIG. 5.

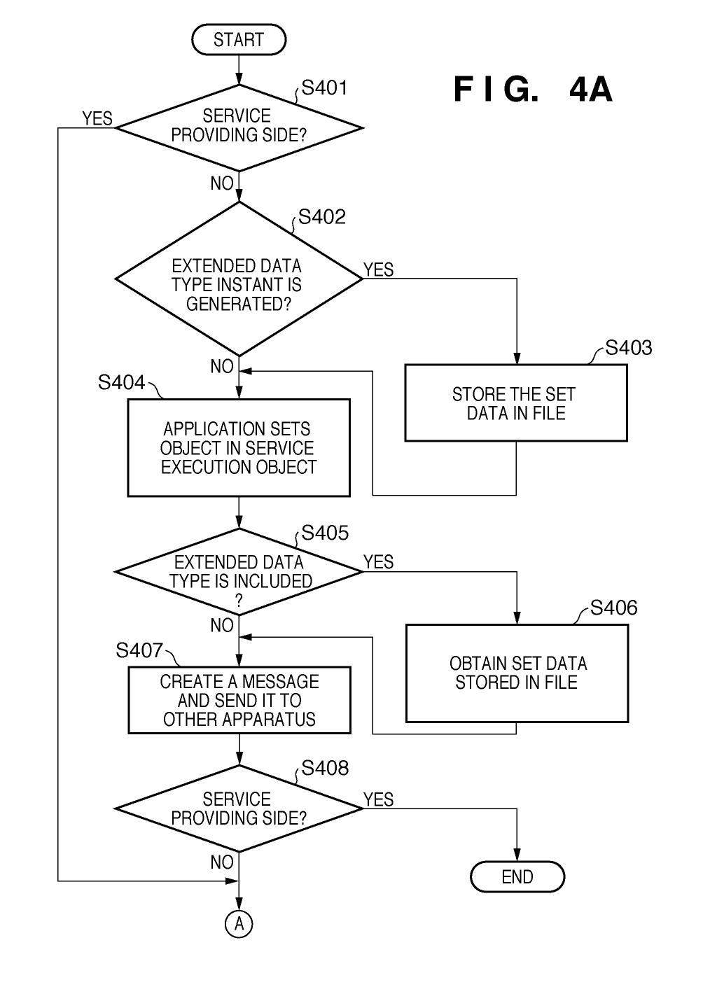

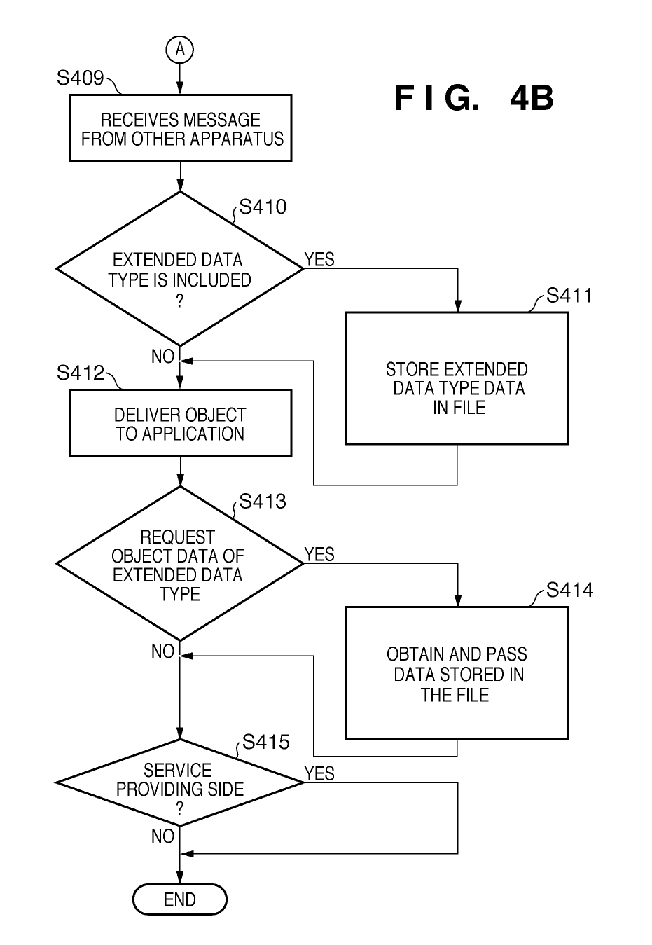

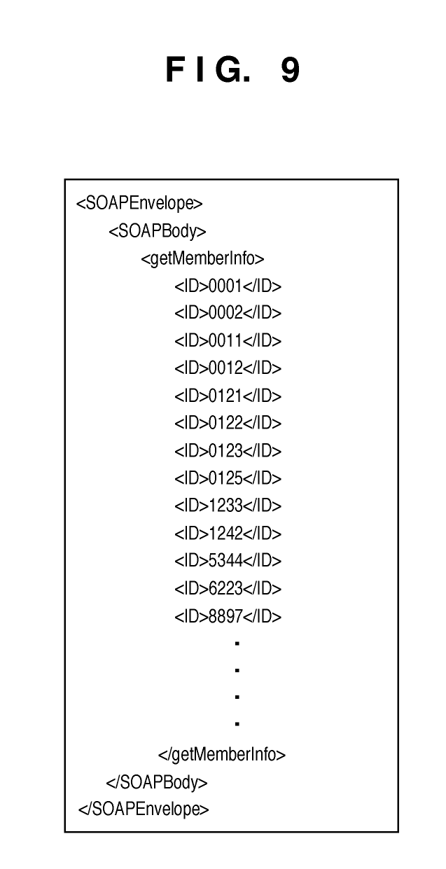

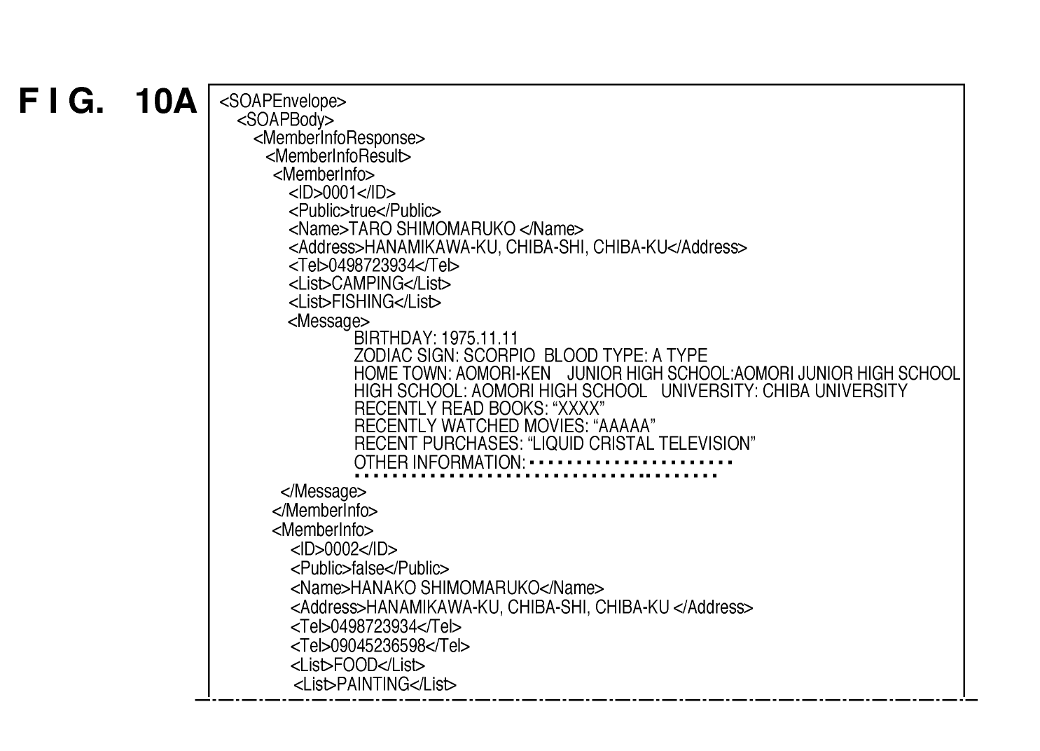

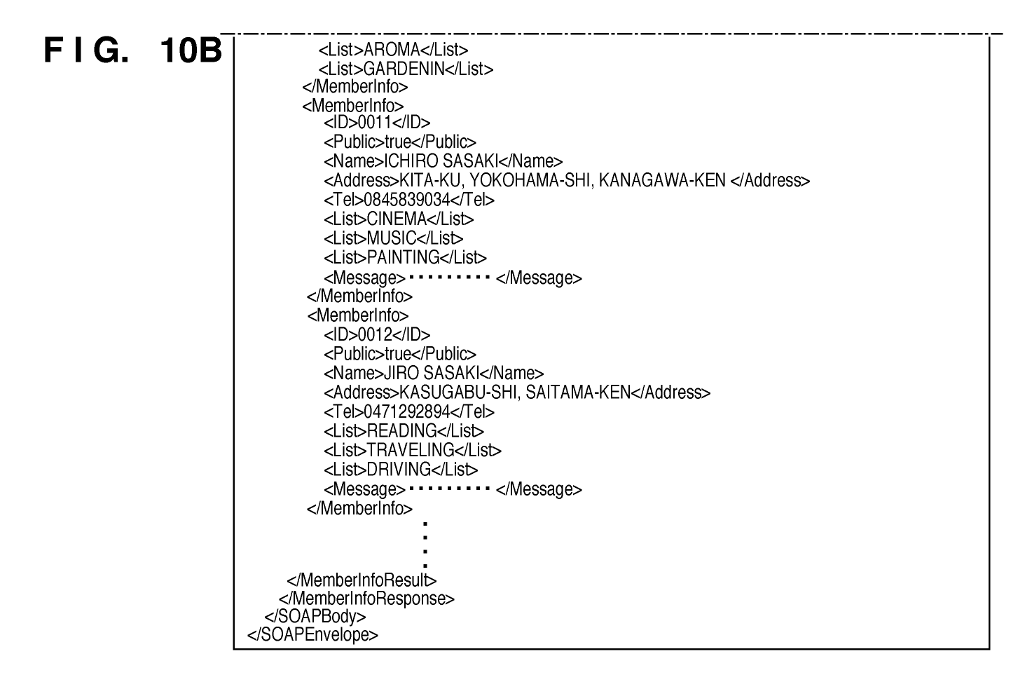

Next, the processing of the service execution processing unit 205 is explained using FIGS. 4A and 4B. In this process, the service execution processing unit 205, by using the service execution object 209 generated by the service execution object generation unit 204, transmits a message to the other apparatus 101. Additionally, an example of the usage of the Service Execution Object in application 203 is given in FIG. 8. Moreover, an example of the message sent to the service is shown in FIG. 9 and an example of the message received from the service is shown in FIGS. 10A and 10B.

First, in S401, service execution processing unit 205 determines whether it is in the service using side or the service providing side. In this discussion, case of the service using side is explained. In case of the service using side (S401: NO), first the message transformation unit 210 waits for the process of application 203. The application 203, when the operation is called, first generates the instance801 of SringSend class which is of the String extended data type for transmission as shown in 704 of FIG. 7. That is, in S402, the application 203 generates the instance of the extended data type for transmission. Then, the application 203, as shown in 802, by using the addString method, member ID which is the transmitting data is divided and set one by one. Here, the message transformation unit 210, regarding S403, by writing into the set data file serially, save into the memory area 211. Then, when application 203 calls the finish method 803, which represents the complete end of data setting, the message transformation unit 210 concludes writing into the file and closes the file.

Next, the application 203 generates the instance 804 of the Member class, by setting the instance of the StringSend class which has set the data as an argument, and executes the getMemberInfo method 805. Here, the message transformation unit 210, by executing S404, determines whether the extended data type is included in the set data or not in next S405. Since the StringSend class is the extended data type (S405: YES), the process proceeds to S406, and the file in which the set data is written is acquired, from the memory area 211. Next, in S407, the message transformation unit 210 creates the message (FIG. 9) which is transmitted to the other apparatus 101, and transmits it. By doing so, a plurality of ID information set by the application 203 is transmitted to the other apparatus 101 which is the service providing side.

In case the number of IDs set by the application 203 is 10,000, when these are transmitted by the normal service execution object, there will be 10,000 String object arrays. However, according to the service execution object 209 of the present invention, since the data is written in to a file once in S403, creating a different object for every data item is not conducted. Therefore, in case the application is executed on the embedded device with limited memory size, it is possible to prevent the memory drain and transmit large data to another apparatus.

Next, when the service execution processing unit 205 is in the service using side (S408: NO), the process is moved to the object transformation unit 212, and it is waited that a message is received from the other apparatus 101 which is in the service providing side. First, in S409, member information corresponding to the transmitted IDs is received from the other apparatus 101. The received message is shown in FIGS. 10A and 10B. The member information is described in the MemberInfo elements. Next, in S410, whether or not the extended data type is included in the received type of the called service execution object 209 is determined.

Here, the executed receiving type of the getMemberInfo operation is of the MemberInfo extended data type (S410: YES), the process proceeds to S411, and the received data is written in a file and is saved in the memory area 211. Next, in S412, as the return value of service execution object 209 which is called, an object is passed to the application 203. The application 203, as the return value of the operation call 805, MemberInfoReceive class which is in the type of MemberInfo extended data type for receiving, is received. As long as the return value of the hasNext method 806 of MemberInfoRecieve class is true, data exists in the MemberInfo class. The application 203, as long as hasNext method return value is true, calls the nextString method 807.

In S413, the object transformation unit 212, determines that the application 203 has requested for MemberInfo class data which is an extended data type object. Herewith, in S414, the file storing the data of MemberInfo class is obtained from the memory area 211, and these data is passed to the application 203 whenever the nextString method in the application 203 is called.

Then, in case the application 203 obtains the internal field value from the obtained MemberInfo class, the object transformation unit 212 stores all the data in the fields which are not the type of extended data type as it is. Since the field name Tel is a String which has the type of array, application 203 runs a loop just the number of time of the array and obtains the data (808).

On the other hand, in case of field name List data, it is StringArrayReceive class 809 which is a String that has the type of array extended data type. In that case, as long as the return value of hasNext method of StringArrayReceive class is true (810), data exists. Moreover, by calling the setLength method of StringArrayReceive class, the number of arrays received at one time can be set. As mentioned above, since the number of arrays which could be obtained at one time is set to five, it is possible to obtain array of size five at a time. The application 203, as long as the return value of hasNext method is true, calls the nextStringArray method, then the object transformation unit 212 divides the String class array into units with the arrays of size five and returns the results (811).

Moreover, in case of data of field name Message, the StringReceive 812 class has the type of the String extended data type for receiving. Then, by calling the setLength method of StringReceive class, sets the number of characters in the obtained data (813). Additionally, the obtained character number was set to five, it is changed to ten hereinafter. As long as the return value of hasNext method is true (814), data exists. The application 203, as long as the return value of the hasNext method is true, calls the nextString method. The object transformation unit 212 recursively divides the string data by every ten character (815) and returns. In this example, since the service using side is considered (S415: NO), the process is concluded.

As shown in FIGS. 10A and 10B, in response to the 10,000 IDs information of 10,000 member information is returned. Therefore, similar to the time of transmission, when receiving based on the usual Service Execution Object, 10,000 objects array of the MemberInfo can be created. However, when the service execution object 209 according to the present invention is used, the data received in S414 is once written into a file, then, every time a request from the application is received one object is created and data is passed. Therefore, in case an application is required to be executed on a embedded device with memory limitations, it is possible to prevent memory draining and receive large data from the other apparatus.

Moreover, regarding the fields in the MemberInfo class, since the possibility of array size of Tel becoming too large is lower, it may remain as an array; however, the data size of List may become too large, because, there are cases the List needed to be set as an Extended Data type. Moreover, even data of the character string type may become too large data transformation from the character string type into the extended data type may be requested. In this case, as shown in FIG. 6, by creating the extension objective setting file 202, depending on the data content application may create the extended data type freely according to the need.

On the other hand, when the service execution processing unit 205 is providing the service, the above discussed service using side process become inverted. First, the object transformation unit 212 waits for a message to be received from the other apparatus 101 that is in the service using side. Then the message transformation unit 210 waits for the process of the application 203.

In present embodiment, the message transformation Unit 210 once writes the data set to the instance of StringSend class by the application 203, into a file. Then, when the application 203 calls the getMoreInfo method, data is extracted from the once written file, and send these data to the other apparatus 101.

However, the application 203 may first call the getMemberInfo method by setting the instance of the StringSend class as an argument when StringSend class has not yet set any data. In this case, when data is set to this instance by the addString method, from the application 203, without writing these data to a file, the set data is immediately written as the message and transmitted to the other apparatus 101 one after the other. When the application 203 calls the finish method, it is determined that the data setting is completed, the end of the message is written and transmission is ended.

Moreover, in the process shown in FIG. 3, regarding the extension objective setting file 202, as long as the subjected type is not clearly assigned to false, it is considered to be “true” for generating extended data type while functioning. However, regarding the extension objective setting file 202, as long as the subjected type is not clearly assigned to true, it may also set not to generate the extended data type.

Moreover, in the present invention, while explaining the large data storage supported data type, arrays and strings are given as examples. However, List type and Vector type are also included as large data storage supported data type.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-089578, filed Apr. 1, 2009, which is hereby incorporated by reference herein in its entirety.

What is claimed is:

1. A message communication apparatus that receives a message from another apparatus via a network, comprising:
an interpretation unit that interprets an interface definition used for dividing a message to obtain objects; and
an object transformation unit that transforms the received message into divided objects to provide the objects to a request side of the divided objects, in accordance with a result of interpretation using the interface definition.

2. A message communication apparatus that transmits a message to another apparatus via a network, comprising:
an interpretation unit that interprets an interface definition used for dividing a message to set objects; and
a message transformation unit that transforms the divided objects into a single message to transmit the message to a transmission destination of the message, in accordance with a result of interpretation using the interface definition.

3. The message communication apparatus according to claim 1, wherein the object transformation unit transforms the received message into the objects of an extended data type using the extended data type that a data type is extended, the data type designating received data described in the interface definition, the extended data type being able to divide and obtain the message.

4. The message communication apparatus according to claim 2, wherein the message transformation unit transforms the objects set to an extended data type into the single message using the extended data type that a data type is extended, the data type designating received data described in the interface definition, the extended data type being able to divide and set the message.

5. The message communication apparatus according to claim 3, further comprising: a generation unit that determines whether or not the data type includes a predetermined type and that generates an object for generating the extended data type to execute a service in a case where it is determined that the data type includes the predetermined type, or generates an object for using the same type as the defined type to execute a service in a case where it is determined that the data type does not include the predetermined type.

6. The message communication apparatus according to claim 4, further comprising: a generation unit that determines whether or not the data type includes a predetermined type and that generates an object for generating the extended data type to execute a service in a case where it is determined that the data type includes the predetermined type, or generates an object for using the same type as the defined type to execute a service in a case where it is determined that the data type does not include the predetermined type.

7. A message receiving method of a message communication apparatus that receives a message from another apparatus via a network, comprising:
interpreting an interface definition used for dividing a message to obtain objects; and
transforming the received message into divided objects to provide the objects to a request side of the divided objects, in accordance with a result of interpretation using the interface definition.

8. A message transmitting method of a message communication apparatus that transmits a message from another apparatus via a network, comprising:
interpreting an interface definition used for dividing a message to set objects; and
transforming the divided objects into a single message to transmit the message to a transmission destination of the message, in accordance with a result of interpretation using the interface definition.

9. The receiving method of message communication apparatus according to claim 7, wherein in the transforming step, the received message is transformed into the objects of an extended data type using the extended data type that a data type is extended, the data type designating received data described in the interface definition, the extended data type being able to divide and obtain the message.

10. The transmitting method of message communication apparatus according to claim 8, wherein in the transforming step, the objects set to an extended data type into the single message using the extended data type that a data type is extended, the data type designating received data described in the interface definition, the extended data type being able to divide and set the message.

11. A recording medium that record a computer program for implementing a message receiving method of a message communication apparatus that receives a message from other apparatus via a network, in a computer, the method comprising:
interpreting an interface definition used for dividing a message to obtain objects; and
transforming the received message into divided objects to provide the objects to a request side of the divided objects, in accordance with a result of interpretation using the interface definition.

12. A recording medium that record a computer program for implementing a message transmitting method of a message communication apparatus that receives a message from other apparatus via a network, in a computer, the method comprising:
interpreting an interface definition used for dividing a message to set objects; and
transforming the divided objects into a single message to transmit the message to a transmission destination of the message, in accordance with a result of interpretation using the interface definition.

13. The recording medium according to claim 11, wherein in the transforming step, the received message is transformed into the objects of an extended data type using the extended data type that a data type is extended, the data type designating received data described in the interface definition, the extended data type being able to divide and obtain the message.

14. The recording medium according to claim 12, wherein in the transforming step, the objects set to an extended data type into the single message using the extended data type that a data type is extended, the data type designating received data described in the interface definition, the extended data type being able to divide and set the message.
